(19) United States
(12) Patent Application Publication
(10) Pub. No.: US 2012/0002038 A1
(43) Pub. Date: Jan. 5, 2012

(54) MEASURING DEVICE FOR MEASURING DEFORMATIONS OF ELASTICALLY DEFORMABLE OBJECTS

(76) Inventors: Bernhard Furrer, Elsau Raterschen (CH); Theo Knaus, Rorschach (CH); Joachim Tiedeke, Kreuzlingen (CH); Joachim Ihlefeld, Dresden (DE); Christoph Kluser, Wil (CH)

(21) Appl. No.: 13/148,202

(22) PCT Filed: Feb. 5, 2010
(86) PCT No.: PCT/EP2010/000738

§ 371 Date: Sep. 21, 2011

(30) Foreign Application Priority Data
Feb. 6, 2009 (DE) 10 2009 007 935.6

(51) Int. Cl. H04N 7/18

(52) U.S. Cl. 348/129; 348/E07.085

(57) ABSTRACT

A device and a process, for measuring deformations of an elastically deformable object, provides at least one optically detectable mark at a longitudinal position along the one elastically deformable object, as well as at least one camera with a matrix of photosensitive elements. The camera is directed towards the at least one optically detectable mark such that this is imaged on the matrix of photosensitive elements. The image data of the camera are sent to an image processing device, which is set up to determine the position of the mark on the matrix of photosensitive elements on the basis of an image recognition. A deviation of the position of the optically detectable mark from the at least one set point is determined and quantified by a computing device.

### CROSS REFERENCE TO RELATED APPLICATIONS

This application is a United States National Phase application of International Application PCT/EP2010/000738 and claims the benefit of priority under 35 U.S.C. §119 of German Patent Application DE 10 2009 007 938.6 filed Feb. 6, 2009, the entire contents of which are incorporated herein by reference.

### FIELD OF THE INVENTION

The present invention pertains, in general, to the measurement of elastic deformations. The present invention pertains, in particular, to the measurement of deformations of an elastically deformable object, such as an elongated support, for example, a rotor blade of a wind power plant or of a wing of an aircraft.

### BACKGROUND OF THE INVENTION

Especially wire strain gauges (WSG) are known for determining deformations of support elements.

Strain deformations can be detected with these strain gauges. They often form the measuring means of scales and balances of all sizes, ranging from household scales to crane weighers. Deformation measurements in structural steel engineering may likewise be carried out by means of WSG measurements. To measure the deformation on the basis of the change in the resistance of the WSG, bridge circuits, such as, e.g., a Wheatstone bridge, are typically used. The mechanical coupling of the WSG is typically brought about by bonding.

Even though the measurements carried out by means of WSG are of high accuracy, there nevertheless are some drawbacks. If the structures on which the deformation shall be measured are very long and the deformation itself is relatively small, a very long wire strain gauge would have to be used for a reliable measurement. A complicated apparatus would thus be required and the weight will increase as well. In addition, it must be ensured that the connection of the elastic support to the WSG remains stable over a long time.

In addition, a lasting change in the resistance parameters does not make it possible to infer a lasting deformation of the support proper or to determine whether that change is caused possibly by an aging-related change in the resistance values of the WSG or of the bridge circuit.

An in situ monitoring of rotor blades and turbines within a gas turbine engine is known from EP 1 742 015 B1. A device is provided for this, which comprises a camera and a light source, wherein the light source brings about lighting of the rotating component during the operation, while the camera receives an image of the component during the operation. A control device compares the images of the component in order to monitor changes in the component. The camera rotates with the component and delivers images of at least one target section of the component. A comparison of the images received is performed by the control device to detect changes of the component. Since the mark must always be located in the field of view of the camera to verify a deformation, the system is suitable mainly for detecting small deformations.

WO 2004/038328 A2 is similarly based on arranging one or more cameras at a first part of an aircraft structure and target objects at a second part of the aircraft structure for determining deformations of an element of an aircraft, wherein the target objects are located within the field of view of one or more cameras. A series of images are recorded and processed in order to determine the magnitude and direction of a motion of the target object or target objects.

An anemometer for wind turbines, in which a laser support is directed through the pole of the wind turbine towards a target object, is known from EP 1 361 445 A1. The laser support on the target object is recorded with a camera. The direction of wind is determined based on the displacement of the point at which the laser support reaches the target object, which deformation is caused by a deformation of the pole.

U.S. Pat. No. 7,377,181 B2 describes a measuring system for detecting stresses in test objects. A mark pattern with coded marks is applied for this to a test object. Target marks are identified by means of a camera on the basis of the coded marks. To determine stresses in the material, changes in the distance of the target marks are then determined on the basis of the images recorded by the camera. This process is consequently sensitive to strains or compressions, but relatively insensitive to bendings.

### SUMMARY OF THE INVENTION

The basic object of the present invention is therefore to accomplish the above-mentioned objects, especially also for longer measuring sections. This object is accomplished by the subject of the independent claims. Advantageous embodiments and variants of the present invention are described in the respective dependent claims.

Accordingly, the present invention provides for a device for measuring deformations of an elastically deformable object. This device comprises at least one optically detectable mark on a longitudinal position of the elastically deformable object, a camera with a matrix of photosensitive elements for detecting the optically detectable mark, an image processing device and a computing means. The camera is directed here towards the optically detectable mark such that the optically detectable mark is imaged onto the matrix of photosensitive elements, wherein the image data of the matrix of photosensitive elements can be sent to the image processing device. The image processing device is designed to perform image recognition and to determine the position of the optically detectable mark on the matrix of photosensitive elements. The optically detectable mark comprises a code, in which a location information of the position of the optically detectable mark is coded. The computing means is set up, furthermore, to determine and quantify a deviation of the position of the mark from at least one set point, to decode the code and thus to determine the position of the optically detectable mark relative to an optical axis of the camera.

A process for measuring deformations of the elastically deformable object, e.g., of a support structure, is performed by means of this device, wherein optically detectable marks are provided on a longitudinal position of the elastically deformable object, and a camera with a matrix of photosensitive elements for detecting the optically detectable mark, an image processing device and a computing means are used. The camera is directed towards the optically detectable mark such that the optically detectable mark is imaged onto the matrix of photosensitive elements. The image data of the matrix of photosensitive elements are sent to the image processing device. The image processing device subsequently performs an image recognition. The position of the optically detectable mark on the matrix of photosensitive elements is now determined, the optically detectable mark comprising a code, in which a location information of the position of the optically detectable mark is coded. The computing means determines and quantifies a deviation of the position of the mark from at least one set point, decodes the code and thus determines the position of the optically detectable mark relative to an optical axis of the camera.

The present invention makes it possible to detect deformations of the elastically deformable object with high precision even without wire strain gauges. The effort needed for installation is considerably reduced, because bonding of the wire strain gauge is eliminated.

The camera may be arranged at a longitudinal position of the elastically deformable object at a spaced location from the optically detectable mark. As an alternative, the camera may be arranged outside the elastically deformable object. In the embodiment of the elastically deformable object as an elongated support structure, preferably as an aerodynamic blade of a rotor of a wind energy plant, the camera may be arranged in the hub of the rotor. The camera preferably looks in the longitudinal direction along the elastically deformable object onto the mark in this case as well. This can be embodied in a simple manner by arrangement in the extension of the longitudinal direction of the elastically deformable object or even by means of an optical deflecting element in the ray path, e.g., a mirror or a prism.

It is favorable, in particular, to utilize existing hollow spaces in the elastically deformable object by the optically detectable mark being arranged within a hollow space. Such hollow spaces are often present especially in elongated elastically deformable objects. For example, various elastically deformable objects, e.g., tubular or shaft-like supports, are hollow on the inside. It is now advantageous, in general, to light the optically detectable mark by means of a lighting means. A suitable lighting of the optically detectable mark may be embodied by means of a laser. The laser is directed for this towards the mark in parallel to the direction of view of the camera.

It is also possible with the present invention, in particular, in a very simple manner to track and quantify deformations in all directions in space. This can be achieved by providing at least two optically detectable marks located at different distances from the camera along the longitudinal direction of the elastically deformable object. The computing means is set up now to determine and quantify a change in length or a nonuniform deformation of the elastically deformable object on the basis of a comparison of the positions of the two marks. This can be achieved by measuring the deformation at two distances. If a normal deformation, for example, a deflection, is present, both marks are on or in the vicinity of a desired curve. A deviation of the position of the marks from the curvature curve known for the structure may be caused, for example, by a kink or a local weakening of the structure. If such a deviation is detected, for example, a warning signal can be generated or the device with the elastically deformable object can be switched off or brought into a safe state.

The present invention will be described below with reference to the deformation of an elastically deformable support. The present invention may also be applied in the same manner to other elastically deformable objects.

To make it possible to distinguish the optically detectable marks arranged at different distances, different codes of the marks are used, which can then be discriminated with the image processing. Different “colors” could be further distinguishing features. The distinguishing features could also be combined. If different “colors” are used, these can be distinguished by a color camera or by different lightings.

A coding of different marks may advantageously also be achieved by one or more wavelength-selective filters, especially color filters on the marks. In a variant of the present invention, the different marks can then be lighted with different wavelengths and selectively analyzed.

In a variant of the present invention, it is also possible to use more than two marks arranged at different distances from the camera. For example, a plurality of marks may be arranged one after another and viewed with the camera in one axis or angle, and the lateral and/or axial displacement is analyzed.

It is also possible, furthermore, to determine a torsion of the support structure about a longitudinal axis. In a variant of the present invention, a mark with at least two optically detectable marks located at laterally spaced locations from the viewing direction is used for this, and a torsion of the elastically deformable object is determined and quantified on the basis of a rotation of the marks in the image plane. Based on the torsion, the marks rotate about a fulcrum point in the image plane. The fulcrum point does not have to be located itself within the image field. However, the torsion will then nevertheless lead to a change of the angle of the section connecting the two marks.

The present invention is preferably used to determine deformations over greater distances. The length of the optical path between the matrix of photosensitive elements of the camera and the optically detectable mark may be at least 4 m and preferably at least 6 m.

In particular, a regulating means, with which deformations of the elastically deformable object especially of the support structure are counteracted, may also be built up with the present invention. Regulating means with a device according to the present invention for measuring deformations is provided for this, wherein said regulating means comprises an adjusting means with at least one final control element, with which the elastic deformation is counteracted in response to the fact that a deviation of the optically detectable mark from a desired position was quantified by the computing means. An adjustment can be made especially independently whether or not the deformation exceeds a predefined limit value.

According to another aspect of the present invention, the support structure is designed as an aerodynamic blade, which has a device as described herein for measuring deformations.

Furthermore, a rotor of a wind power plant may comprise such an aerodynamic blade as a rotor blade. The camera may be accommodated in the rotor blade. However, it is also possible to arrange the camera in the hub of the rotor of the wind power plant. Electric or electronic components within the rotor blade can thus be avoided.

However, it is also conceivable that the elastically deformable object is designed as a wing of an aircraft. The camera may be arranged in the wing of the aircraft in this case. As an alternative, the camera may also be provided in the area of the transition of the wing to the fuselage of the aircraft.

The present invention may be used especially advantageously together with a regulating means, as described above, wherein the final control element comprises a final control element for adjusting the pitch angle of the aerodynamic blade (at the rotor blade of the wind power plant or the wing of the aircraft), and wherein the adjusting means changes the pitch angle of the aerodynamic blade. The lift of the aerodynamic blade may also be changed, in general, by means of one or more final control elements. What is meant here is especially the use of the device according to the present invention at the flaps of the wings of an aircraft.

To make it possible to exactly quantify a deformation on the basis of the position of the mark on the matrix of photosensitive elements of the camera, it is valuable to know the distance of the mark from the matrix of photosensitive elements. The mark is arranged at a defined distance at the elastically deformable object in the simplest case. However, it is also possible to design the measuring means as a self-calibrating measuring means. Provisions are made for this according to one embodiment of the present invention for the length of the optical path from the matrix of photosensitive elements to the mark to be determined by a flight time measurement of a light support or on the basis of the size of a pattern projected onto the mark. For example, a laser may project a grid onto the surface of the pattern. The distance from the camera can then be determined automatically by means of triangulation in a simple manner. It is correspondingly also possible, depending on the design of the mark, to perform a calibration by triangulation on the basis of the size of the mark or the distance from at least two marks in the image plane.

The optically detectable mark comprises a code, in which a location information of the position of the mark is coded. the path of deformation relative to a reference position can be determined on the basis of a displacement of the location of the mark. The code may be in the form of a strip and/or dot pattern or in the form of any symbols, e.g., characters, textures, color marks. The code represents a position code, preferably in two dimensions. If the elastically deformable object is deformed, the location of the camera in relation to the optically detectable mark migrates corresponding to the relative motion brought about by the deformation between the camera and the optically detectable mark. The determination of the position of the direction of the camera has the special advantage that a large measuring range is obtained with high measuring accuracy at the same time. The mark does not move out of the field of view of the camera even in case of great deformations, because new code elements enter the field of view of the camera. Furthermore, it is advantageous now that the effect of distortions of the optical system of the camera is limited or even ruled out, because the location of the position determination remains stationary in relation to the optical axis of the camera.

In addition to the location information coded in the mark, a synchronization pattern, for example, a grid, may be contained.

Especially local coordinates are coded as location information. These do not have to indicate the local position in absolute units in relation to a preset reference point. A relative indication is sufficient. For example, an unambiguous, optionally also cyclically recurring number of the code units may be provided as a relative indication. A certain point on the object will now correspond to the number of each code unit.

The image detected changes by translation and rotation of the elastically deformable object. Besides a pure displacement, distortions occur, which can be described by an affine transformation. The translation and rotation parameters are now calculated from a measured image. The measuring accuracy is determined, among other things, by the precision of the grid detection. Fast edge detectors, preferably detectors with a subpixel accuracy, are especially advantageous for use as part of the image processing device.

The measurement of the change in the position of the pattern in relation to the reference position can be carried out by the computing means as follows: The contours are approximated by digital sections. Intersections of the grid lines are determined. These intersections are stored in a first matrix in an ordered sequence, and intersections connected by digital sections are stored in identical rows or columns of the first matrix. Unoccupied dots are marked as open. The principal axis transformation between a second matrix learned as a reference position and the first matrix yields the six transformation parameters needed, namely, three translation parameters x, y, z, and three rotation parameters (α, β, γ). The use of a CMOS sensor with integrated gradient filter and digital signal processor (DSP) is especially advantageous. Very fast and cost-optimal single-chip processing can be carried out with this hardware. The image processing device and the computing means can thus be designed such that they are integrated at least partly in the camera.

It is not necessary for the local information of the code to correspond to the local position in an absolute manner. A relative information is likewise sufficient if calibration is performed. However, it is also advantageous if it is known at what distances along the code the local information is stored. The absolute value of the lateral displacement of the mark caused by a deformation of the elastically deformable object can be obtained in this case directly from the decoding of the local information. If it is known, for example, that the local information is at certain distances, the displacement of the pattern in relation to the reference position can be obtained by simple differentiation of the decoded local coordinates.

A two-dimensional code is especially suitable. To improve the measuring accuracy, a plurality of independent measuring fields can be embodied with such a code by determining, e.g., an additional position with a second camera. It is likewise possible to arrange the code on a nonplanar surface and to scan two areas, which are remote from each other and are at an angle in relation to one another. The local information is then coded in such a mark for the locations along two nonparallel, preferably perpendicular directions. A displacement in relation to a reference position along two non-parallel axes can be correspondingly obtained here by decoding the mark from the image information by means of the image processing device.

It is, in general, advantageous to cover a section—or an area in case of a two-dimensional code—with the mark, which is so large that the displacements based on the elastic deformations to be measured are located within the section or area.

The determination of translations and rotations of an object in three directions in space by means of a mark arranged on an object with local information coded therein is not limited to elastic deformations of the object. This embodiment of the present invention is rather suitable, quite generally, for detecting and quantifying motions of objects in any desired direction.

According to another aspect of the present invention, a device is therefore provided for measuring a change in position, especially a translation and a rotation of an elastically deformable object, which means comprises an optically detectable mark arranged on the object with a coded local information. A mapping table, in which the geometric positions of at least some code units at a reference position are contained, is now stored in the computing means. The image processing device is set up to recognize and decode the code of the mark and thus to assign the decoded local information to an image position. The computing means is set up to determine the change in the position of the mark of the elastically deformable object.

A two-dimensional code especially suitable for the present invention is described in EP 1 333 402 A1, which is also made the subject, to the full extent, of the present invention in reference to the embodiment and expression of the code (corresponding U.S. Pat. No. 7,066,395 and U.S. Pat. No. 7,278,585 are hereby incorporated by reference in their entirety).

The present invention can be used, in general, to monitor, control and/or regulate the functionality of an elastically deformable object, for example, a rotor blade of a wind power plant. This may also be performed prospectively by comparing motion patterns measured by the computing means with stored motion patterns. One example is a vibration with a still permissible, but increasing amplitude. If, for example, such a motion pattern is detected, it can be counteracted early by a suitable regulation, e.g., by changing the pitch angle.

The present invention will be explained in more detail below on the basis of exemplary embodiments and with reference to the attached drawings. Identical reference numbers designate identical or corresponding elements. The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 is a view of a rotor of a wind power plant with parts of a measuring means for measuring deformations on a rotor blade;

FIG. 2 is a cross sectional view through a rotor blade;

FIG. 3 is a view of a camera of the measuring device;

FIG. 4 is a view showing a variant of the rotor from FIG. 1;

FIG. 5 is a view showing a video image recorded by the camera of the marks in the rotor blade of the example shown in FIG. 5;

FIG. 6 is a diagram with deflection curves of the rotor blade;

FIG. 7 is a view showing an arrangement of the measuring means with a two-dimensional mark code; and

FIG. 8 is a view showing an arrangement with a code with projection-corrected grid.

### DESCRIPTION OF THE PREFERRED EMBODIMENTS

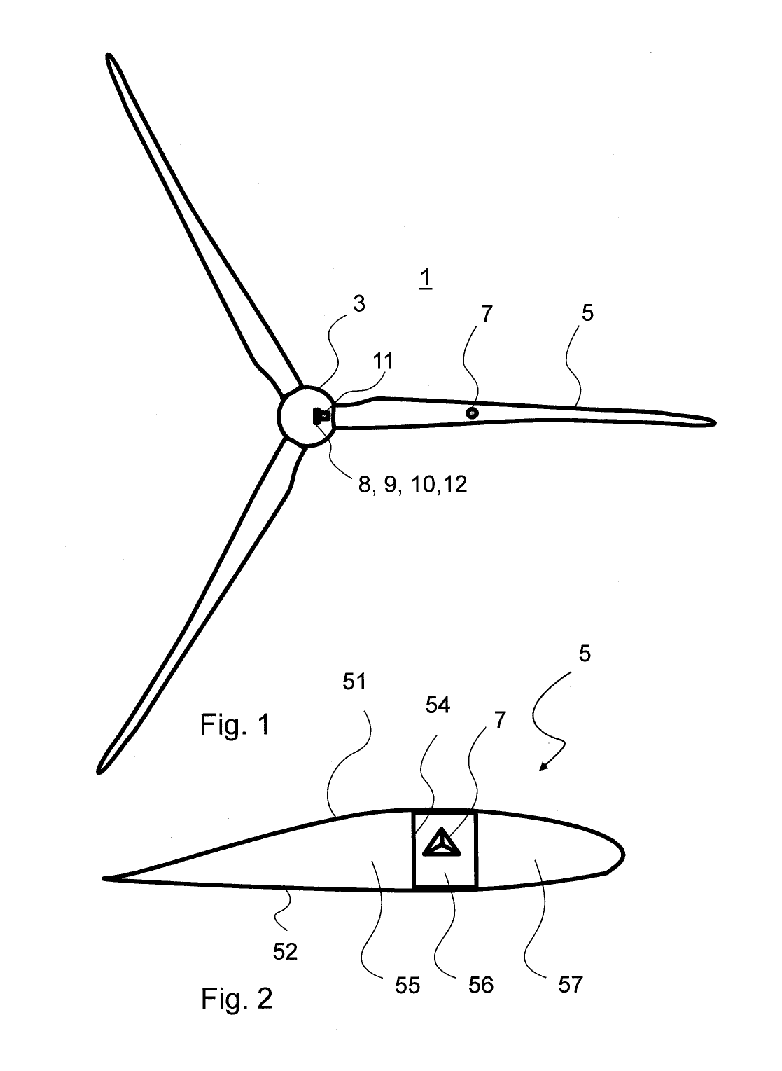

Referring to the drawings in particular, FIG. 1 shows a part of the device according to the present invention for measuring deformations on a rotor blade of a rotor 1 of a wind power plant. Rotor 1 comprises three rotor blades 5. Each rotor blade forms an elastically deformable object. Rotor 1 incorporates parts of a device for measuring deformations of the rotor blades 5, whose principle will be explained below. The task of the measuring means is to measure the deflection of the rotor blade 5 of the wind power plant in two axes.

The means for measuring deformations is based on at least one optically detectable mark 7 at a longitudinal position along the rotor blade 5, as well as an electronic camera 9. Camera 9 comprises a lens 11 and a matrix of photosensitive elements 12. Lens 11 of the camera 9 is directed towards the at least one optically detectable mark 7, so that this is imaged on the matrix of photosensitive elements 12. Furthermore, an image processing device 8 is provided, to which image data of the camera 9 are sent. The image processing device 8 is set up to determine the position of mark 7 on the matrix of photosensitive elements 12 on the basis of an image recognition. Furthermore, a computing means 10 is provided in order to determine and quantify a deviation of the position of mark 7 from at least one set point. Both the image processing device 8 and the computing means 10 are integrated in camera 9 in the embodiment shown. The camera 9 can thus already make available at an output the data of the deviation from the desired position, for example, of the position of the nonmoving rotor blade 5 during a calm.

The camera 9 is arranged in the hub 3 of the rotor 1 in the embodiment shown in FIG. 1. No electronic components are thus necessary in the rotor blade 5. Hub 3 of the rotor 1 can be shielded from lightning in a simpler manner than the rotor blades 5. The camera 9 in the rotor 4 can thus be protected against failure caused by lightning. However, as an alternative, the camera 9 may also be arranged directly at or in the rotor blade 5. The measuring means according to the present invention is shown at a rotor blade 5 in the embodiment according to FIG. 1. However, the device according to the present invention may also be provided on a plurality of or all rotor blades 5 of rotor 1.

If a deformation of the rotor blade 5 occurs during operation due to the blowing wind, the position of mark 7 moves at right angles to the longitudinal axis of the rotor blade 5. The longitudinal axis of the rotor blade 5 also represents the direction of view of the camera 9 at the same time. The position of the image of the mark 7 on the matrix of photosensitive elements of camera 9 is thus displaced. If the distance of camera 9 from mark 7 is known, the deformation at the site of mark 7 can be easily calculated from the displacement by means of the computing means 10.

The distance between the matrix of photosensitive elements 12 of camera 9 and mark 7 is preferably 4 m and especially preferably 6 m. A bending of the rotor blade 5 can thus be measured with high accuracy. On the other hand, it is favorable, in general, to select the distance such that it does not exceed 40 m, because the rotor blade 5 would otherwise bend under the loads occurring in a short time to such an extent that the mark 7 would no longer be within the image field of camera 9 but would be covered by the curved walls of the rotor blade 5.

A regulating means, with which the deformations can be counteracted, may be provided, in general, in an especially preferred manner. The regulating means comprises for this an adjusting means with at least one final control element, with which the elastic deformation is counteracted by responding to the fact that a deviation of mark 7 from a desired position, especially the exceeding of a limit value, was quantified by the computing means 10.

A final control element is used in case of the rotor 1 of a wind power plant shown in FIG. 1 to adjust the pitch angle of the rotor blades 5, so that the adjusting means changes the pitch angle of the rotor blades 5 as a function of the measured deformation.

FIG. 2 shows a cross section through the rotor blade 5. Rotor blades 5 of wind power plants, as well as other aerodynamic blades, such as especially also aircraft wings, typically comprise hollow spaces extending along their longitudinal direction. In the example shown in FIG. 2, the rotor blade 5 comprises an upper shell 51 and a lower shell 52, between which a spar 54 is arranged. A shaft-like hollow space 56 extends within spar 54. The other intermediate spaces 55 and 57 may be hollow as well. It is advantageous to arrange the mark 7 of the measuring means in the interior of rotor blade 5. As an example, mark 7 is inserted into the shaft-like hollow space 56 in FIG. 2. Active lighting of the mark 7 is provided for the camera 9 to be able to detect the mark 7.

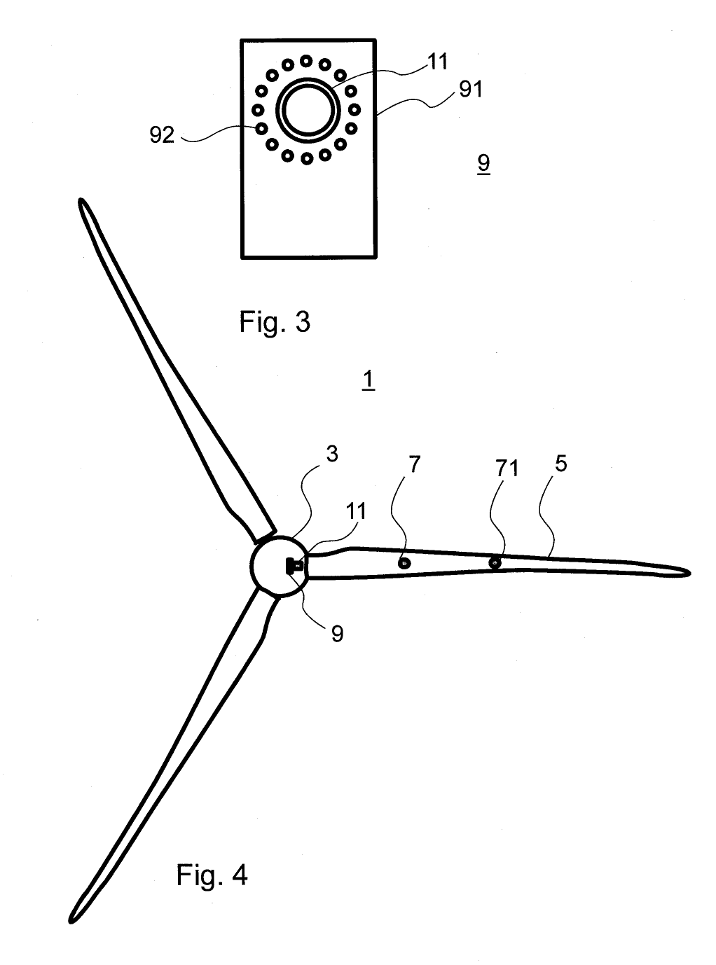

FIG. 3 shows an example of s suitable camera 9. Light-emitting diodes 92 are provided in this example around the lens 11 at the housing 91 of camera 9. The light-emitting diodes 92 light the mark 7 along the direction of view of camera 9.

FIG. 4 shows a variant of the rotor 1 from FIG. 1. Two marks 7, 71 located at differently spaced locations from the camera 9 along the longitudinal direction of the rotor blade 5 are provided in this variant. It is now possible, based on the position of these marks 7, 71, to determine and quantify a nonuniform deformation of the rotor blade 5.

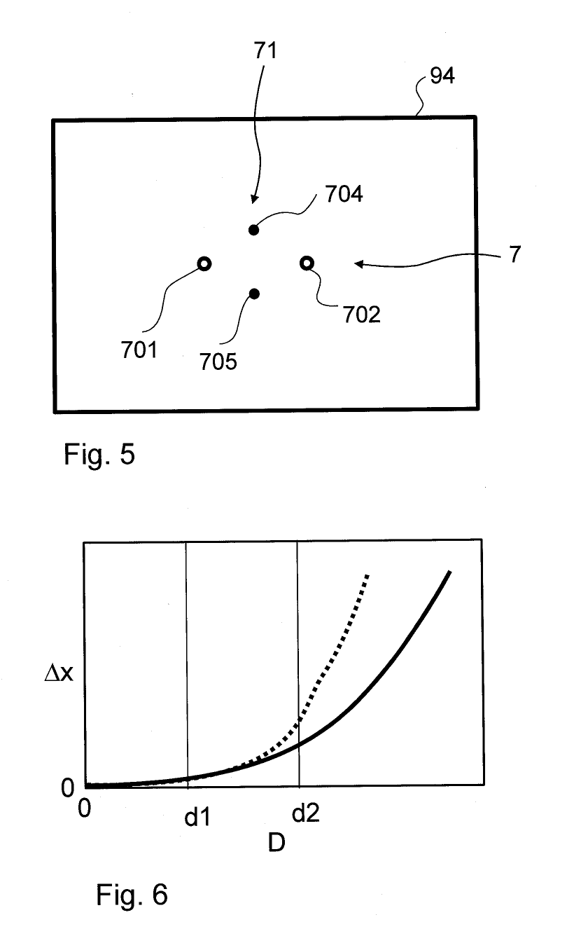

In addition, two or more marks 704, 705 located at laterally spaced locations from the longitudinal axis of the rotor blade 5 may be provided as well (see FIG. 5). A torsion of the rotor blade 5 can thus also be determined and quantified on the basis of a rotation of the marks 704, 705 in the image plane.

FIG. 5 shows for this an image from the image recorded by the camera 9 for the rotor 1 shown in FIG. 4.

Each of the marks 7, 71 in the example shown in FIG. 5 comprises two pairs of marks 701, 702 and 704, 705 located at laterally spaced locations. To make it possible to distinguish the marks 7, 71 from each other, the marks have discriminable properties, e.g., a different color or shape. This is symbolized in FIG. 5 by the different filling of the marks, which re circular here. The different marks 7, 71 may also be coded in an advantageous manner by one or more wavelength-selective filters, especially a color filter. If different colors are reflected back to the camera 9 from the marks 7, 71, the different marks 7, 71 can be lighted with different wavelengths and analyzed selectively at different times in a variant of the present invention.

The mounting distance of the marks 7, 71 from the camera 9 can also be measured from the distance of the two marks 7, 71 and the measuring arrangement can thus be calibrated, because the real distance of the marks 701, 702 and 704, 705 belonging to a mark 7, 71 is known. It can thus be recognized based on the recording 94 in FIG. 5 that the distance of the marks 704, 705 is shorter than the distance of the marks 701, 702.

Since the distance between the imaged marks 7, 71 changes with the distance of these marks, a deformation in the longitudinal direction of the rotor blade 5, especially a strain of the rotor blade 5, can also be detected and quantified by determining the distance in a simple manner.

Based on the two marks 7, 71 arranged in one line, it is also possible now to measure a torsion of the rotor blade 5. If a torsion occurs between the camera 9 and the marks 7, 71, the angle of the line connecting the respective marks 701, 702; 704, 705 belonging to the marks 7, 71 changes in the image plane.

According to one exemplary embodiment, the following parameters may be used for the measuring means:
The length of the optical path between the matrix of photosensitive elements 12 and mark 7, 71 is selected within a distance of about 40 m. The measuring time equals 16.6 msec corresponding to an image repetition rate of 60 images per second. The X deviation, Y deviation, torsion, distance of the marks 701, 702; 704, 705, vibration amplitude and vibration frequency of typically up to 20 Hz can be measured. A measuring accuracy of 1/7,000 of the maximum detectable deviation along the X axis (the direction along the longer side of the image shown in FIGS. 5) and 1/4,000 of the maximum detectable deviation along the Y axis can already be achieved with a simple matrix of photosensitive elements 12.

FIG. 6 shows an example of how a nonuniform sag of the rotor blade 5 can be determined and quantified on the basis of a comparison of the positions of the two marks.

The diagrams of the deflection Δx of the rotor blade 5 as a function of the distance D from the hub 3 are shown in FIG. 6. Mark 7 is arranged at position d1 and mark 71 at position d2.

The curve drawn in solid line shows as an example a normal, uniform deflection of an intact rotor blade 5. If the rotor blade 5 has a kink or, for example, also a crack, which leads to weakening of the structure of the rotor blade 5, increased deflection will occur behind the crank or kink site. Such an exemplary deflection curve is indicated by broken line. The ratio of the deviations Δx is correspondingly greater here.

If it is determined by the computing means 10 on the basis of the measured data that such an anomalous deflection is present permanently, it is possible to initiate, for example, switching off of the wind power plant or the starting of a safe state. This safe state can be achieved, for example, by bringing the rotor blades 5 into a neutral position, in which case the defective rotor blade 5 is pointing downward.

By arranging two marks 7, 71 in the depth of the rotor blade 5, the bending can be measured at two distances. It is possible as a result to check whether the rotor blade 5 is bent uniformly or whether a kink is present, because the two points are no longer located on a curvature curve known from the structure.

A mark 7 in which the location information of the mark 7 is coded offers, among other things, the advantage that the deformation of the rotor blade 5 can always be determined on the basis of the imaged and decoded information, which is related to the center of the image or another desired reference point in the image plane. Measurement errors, which may develop due to distortions of the lens, are thus eliminated.

A displacement of the marks 7 can be detected and quantified with the measuring means described on the basis of FIGS. 1 through 6 in all directions in the image plane, i.e., consequently in two dimensions at right angles to the direction of view of the camera 9. It is favorable here to select a two-dimensional code, in which location information is coded for the locations along two non-parallel, preferably perpendicular directions.

A preferred code and its arrangement as a mark 7 in or at the rotor blade 5 will be described in more detail below.

Just as in the above-described exemplary embodiments, a camera 9 and one or more marks 7 in the form of labels with the code are arranged in the rotor blade 5.

The label or labels is/are arranged not only on an individual planer surface, but on at least two surfaces or surface elements arranged at an angle in relation to one another, for example, also on a curved surface.

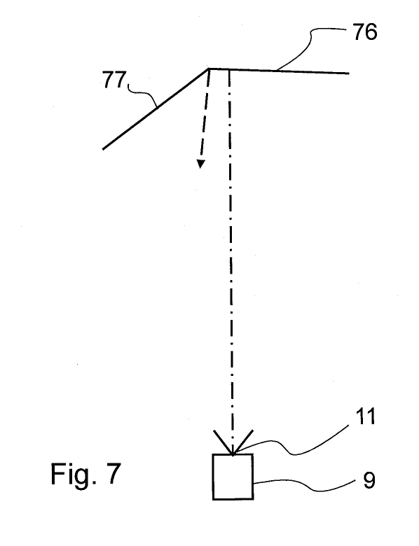

FIG. 7 shows an exemplary arrangement with surfaces 76, 77, which are arranged obliquely in relation to one another and which are provided with a mark 7 in the form of a two-dimensional code.

The grid may be equidistant or corrected for projection, so that the resolution and hence the measuring accuracy are approximately constant for the directions being considered.

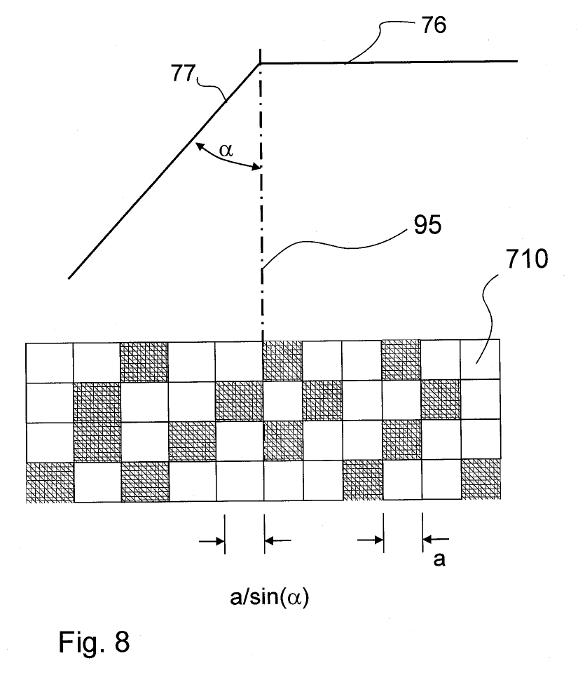

FIG. 8 shows a code with a grid corrected for projection. The grid width of the matrix or of the grid of the code on the surface 76 arranged at essentially right angles to the direction of view 95 of the camera 9 has a value a, while the grid width of the surface 77 arranged at an angle α to the direction of view 96 of camera 9 is increased by a value a/sin(α) in the direction of view.

The individual grid fields 710 represent individual bits of the code. To make it possible to recognize the fields and to decode the code, the fields are with different contrasts as a function of the bit value. For example, dark and light or absorbing and reflecting fields may be used. The bit values are represented by different fillings of the grid fields in FIG. 8. For example, the shaded fields may represent logic zeros and the nonshaded fields logic ones or vice versa.

In contrast to a simple grid an absolute reference point can be guaranteed with the code. It is possible to print or generate in another manner a suitable code endlessly by the information being distributed two-dimensionally in a certain manner such that the global positioning can be calculated completely with a maximum of four 6×6 grid environments. Such a two-dimensional code, as it is preferred for the present invention, is known from EP 1 333 402 A1.

The arrangement of the code on a plurality of surfaces or surface elements, which are at different distances from the camera 9, such as the exemplary arrangement of the surfaces 76, 77, is used, corresponding to the arrangement shown in FIG. 4, to detect a deformation along the direction of view of the camera 9 as well. Code units are decoded for this on a plurality of surface elements arranged at different distances and the location information of these code units is analyzed. If a displacement occurs in the longitudinal direction, the pieces of location information will also change relative to one another on certain associated image parts. Instead of an analysis of different image parts, it is also possible to use a plurality of cameras 9, which detect different surface elements. As in FIG. 4, codes may also be arranged on a plurality of surfaces arranged one after another in the direction of view of the camera 9. Nonlinear deformations can thus be detected and/or the measuring accuracy can be improved.

A film printed with such a code (or a similar structure) is now bonded or attached in another manner to the object to be measured.

After finding the grid by the image processing device, the code content is binarized and entered into a matrix. The global position in the grid can then be decoded from this. The decoding process is also described in EP 1 333 402 A1.

If the geometry of the surface is already known in advance, defined points Pi(x,y,z) of the grid can be assigned to 3D coordinates.

A precisely assigned table is obtained in the form of:

Pᵢ(x,y,z)←→angleᵢ(α, β, γ).

This table can then be stored in the computing means 10 to calculate the current position or the deformation of the rotor blade 5.

The angles are obtained from the central projection of the camera image through the aperture of the lens. The displacement of the labeled object in relation to a reference position can be finally outputted from the set {P,angle} by matching by determining the parameters of a principal axis transformation. The displacement vector (X0, Y0, Z0) as well as the rotation in three angles (α0, β0, γ0) are measurable.

The preferred code will be described in more detail below. The two-dimensional code has the following properties: The code comprises a synchronization code used for synchronization and a position-dependent code, the position data being coded in code units of a fixed size. The synchronization code is variable and distributed geometrically uniformly on the surface. The synchronization code makes possible, besides, the synchronization in the X and Y directions by means of two variable components. Specifically, the synchronization code is so variable that it contains itself position-dependent data, preferably the least significant bit or bits of the coded position data. It is also possible to use the only slowly changing most significant bit. To make the synchronization especially reliable, the synchronization code may occur with the double spatial frequency compared to the position-dependent code. To obtain especially small code units, it is now also possible not to code the location information completely in a code unit. The complete location information can then be realized by detecting a field having at most 6 times the size of a code unit, preferably at most 4 times the size of a code unit. The data may be split such that missing bits of a position datum are complemented from adjacent code units.

The above exemplary embodiments pertain to the rotor blade or rotor blades of a wind power plant. The present invention may also be used for aircraft wings in a corresponding manner. However, it is possible here to regulate the lift by means of one or more control surfaces and flaps, e.g., the aileron and spoiler or flaps. Since the deformation of the wing typically precedes a change in the position of the aircraft, it is possible, among other things, to stabilize the attitude by a regulating means, which controls the flaps and/or control surfaces on the basis of the measurement of the deflection and/or torsion of the wing. A measuring means according to the present invention may advantageously also be provided in the fuselage in order to make it possible to recognize stresses of the support structure here.

It is obvious to the person skilled in the art that the present invention is not limited to the above-described exemplary embodiments but may be varied in many different ways. In particular, the present invention can also be applied to other elastically deformable objects.

While specific embodiments of the invention have been shown and described in detail to illustrate the application of the principles of the invention, it will be understood that the invention may be embodied otherwise without departing from such principles.

1. A device for measuring deformations of an elastically deformable object, the device comprising:
an optically detectable mark on a longitudinal position of the elastically deformable object;
a camera with a matrix of photosensitive elements for detecting the optically detectable mark;
an image processing device and a computing device, wherein the camera is directed towards the optically detectable mark such that the optically detectable mark is imaged on the matrix of photosensitive elements, wherein image data of the matrix of photosensitive elements is sent to the image processing device, the image processing performs an image recognition and determines the position of the optically detectable mark on the matrix of photosensitive elements, wherein the optically detectable mark comprises a code, in which a location information of the position of the optically detectable mark is coded, wherein the computing device determines and quantifies a deviation of the position of the mark from at least one set point, to decode the code and thus to determine the position of the optically detectable mark relative to an optical axis of the camera.

2. A device in accordance claim 1, wherein the elastically deformable object is designed as an elongated support structure.

3. A device in accordance with claim 1, wherein:
the elongated support structure is an aerodynamic blade of a rotor of a wind energy plant; and
the camera is arranged in the hub of the rotor.

4. A device in accordance with claim 1, wherein at least two optically detectable marks are provided, which are arranged at different distances from the camera, wherein the computing device determines and quantifies a change in length or a nonuniform deformation of the elastically deformable object on the basis of a comparison of the positions of the two marks.

5. A device in accordance with claim 1, wherein the optically detectable mark is arranged within a hollow space of the elastically deformable object and is lighted by a lighting a device.

6. A device in accordance with claim 1, wherein the code is provided as a two-dimensional code, in which location information is coded for the locations along two non-parallel directions.

7. A device in accordance with claim 1, wherein an assignment table of three-dimensional coordinates to the location information of the optically detectable mark, is stored in the computing device.

8. A device in accordance with claim 1, wherein the computing device calculates from the decoded location information a principal axis transformation, with which the optically detectable mark is transformed from the reference position into the measured position and the change in position in relation to the reference position can be determined and quantified on the basis of the principal axis transformation.

9. A device for measuring deformations in accordance claim 1, further comprising an adjusting device with at least one final control element, with which the elastic deformation is counteracted in response to the fact that a deviation of the optically detectable mark from a desired position was quantified by the computing device wherein the device for measuring deformations with the adjusting device forms a regulating device.

10. A device in accordance with claim 9, further comprising a rotor of a wind power plant as the elastically deformable object wherein the final control element comprises a final control element for adjusting the pitch angle of the rotor, and wherein the adjusting a device changes the pitch angle of the rotor blade.

11. A process for measuring deformations of an elastically deformable object, the process comprising the steps of:
providing at least one optically detectable mark on a longitudinal position of the elastically deformable object;
providing a camera with a matrix of photosensitive elements for detecting the optically detectable mark;
providing a processing device and a computing device; and
using the image processing device and the computing device with the camera with the matrix of photosensitive elements for detecting the optically detectable mark;
directing the camera towards the optically detectable mark such that the optically detectable mark is imaged on the matrix of photosensitive elements, wherein the;
sending image data of the matrix of photosensitive elements to the image processing device;
performing an image recognition with the image processing device and determining a position of the optically detectable mark on the matrix of photosensitive elements, wherein the optically detectable mark comprises a code, in which location information of the position of the optically detectable mark is coded; and
determining and quantifying, with the computing, a deviation of the position of the mark from at least one set point, and decoding code and thus determining the position of the optically detectable mark relative to an optical axis of the camera.

12. A process in accordance with claim 11, wherein:
the elastically deformable object is designed as an aerodynamic blade; and
detected and quantified deformation of the aerodynamic blade and the pitch angle of the blade or the lift thereof is changed by a device of at least one final control element as a function of the deformation.

13. A process in accordance with claim 11, wherein two optically detectable marks located at laterally spaced locations in relation to the direction of view are used, and a torsion of the elastically deformable object is determined and quantified on the basis of a rotation of the optically detectable marks in the longitudinal axis of the elastically deformable object.

14. A process in accordance with claim 11, wherein the length of the optical path from the matrix of photosensitive elements to the optically detectable mark is determined by a flight time measurement of a light support or on the basis of the size of a pattern projected onto the mark.

15. A device in accordance claim 2, wherein the elongated support structure is an aerodynamic blade of a rotor of a wind energy plant.
